(19) United States
(12) Patent Application Publication
(10) Pub. No.: US 2017/0188613 A1
(43) Pub. Date: Jul. 6, 2017

(54) Meat Crisps And Processes For Producing Same

(71) Applicant: Kraft Foods Group Brands LLC, Chicago, IL (US)

(72) Inventors: Alba Yesenia Rosales, Naperville, IL (US); Jose Alfredo DeLaTorre, Oak Park, IL (US); Tracy Rene Matteson, Madison, WI (US)

(21) Appl. No.: 15/322,655

(22) PCT Filed: Sep. 24, 2015
(86) PCT No.: PCT/US2015/051908

§ 371 Date: Dec. 28, 2016

Related U.S. Application Data
(60) Provisional application No. 62/054,708, filed on Sep. 24, 2014.

(51) Int. Cl. A23L 13/60

(52) U.S. Cl. CPC A23L 13/67; A23V 2002/00

(57) ABSTRACT

Meat crisps and methods of producing the crisps are provided. The meat crisp is a crunchy meat product comprised of at least ground meat or whole muscle meat pieces. Generally the meat is dehydrated and the crunchy meat crisp has a water activity (A_{w}) of about 0.3 to about 0.6. The meat crisp also may have a moisture percentage of about 4.5% to about 15%, a crisp thickness of about 0.025-in. to about 0.25-in., and a crispness value of less than 731 kg·seconds such that the meat crisp has an appearance, texture, flavor, eating quality, and/or mouth feel similar to other snack chips such as potato or corn chips. The meat crisp may be produced by slicing a cooked meat log and then dehydrating the cooked slice. Alternatively, the meat crisp may be produced by forming thin raw meat films or sheets that are subsequently cooked and dehydrated.

### TECHNICAL FIELD

This disclosure relates generally to meat products and, more particularly, crunchy or crispy meat products.

### BACKGROUND

Snack foods and other on-the-go consumables are becoming increasingly popular. These products are ready-to-eat and typically do not require specialized storage conditions. While there are many snack foods available for purchase, consumers are often interested in food products that meet certain dietary goals such as, for example, higher in protein, dairy-free, and low-carbohydrate, among others. Many of the currently available product offerings do not meet many of the consumers' preferences. Indeed, many consumers find current snack food offerings unsatisfying or not easily available for consumption.

The currently available food products that are generally higher in protein and lower in carbohydrates typically do not satisfy the consumers' desire for a crispy or crunchy snack food. For example, many prepared meat products like beef jerky, ready-to-eat bacon, or beef sticks are chewy or soft. On the other hand, many of the readily available crispy or crunchy snack foods are cooked by deep frying in oil, which increases the fat content.

In addition, preparing such high-protein and low-carbohydrate snack type foods for consumption out of the home can be labor intensive and time consuming. A convenient, ready-to-eat meat product that is crunchy and flavorful is desired by many consumers.

### SUMMARY

A meat crisp product and methods of producing the product are provided herein. The meat crisp is comprised of at least ground meat or whole muscle meat pieces. Generally the meat is dehydrated and the crunchy meat crisp has a water activity (A_{w}) in a range of about 0.3 to about 0.6, a moisture percentage in a range of about 4.5% to about 15%, a crisp thickness in a range of about 0.025-in. (about 0.635 mm) to about 0.25-in. (about 6.35 mm), and a crispness value of less than 731 kg·seconds. In another illustrative approach, the meat crisp has a thickness of about 0.02-in. (about 0.508 mm) to about 0.04-in. (about 1.016 mm). In yet another illustrative approach, the meat crisp has a thickness of about 0.025-in (about 0.635 mm) to about 0.035-in. (about 0.889 mm). In another approach, the meat crisps have a thickness of about 0.03-in. (about 0.762 mm).

A ready-to-eat, shelf stable packaged food product described herein may include a plurality of proteinaceous chips, a package containing the chips, and a modified atmosphere surrounding the chips within the package. Each of the crisps or chips may have a composition of about 30% to about 75% protein, less than about 30% fat, a moisture percentage of about 4% to about 15%, a salt percentage of less than about 10%, a pH of about 4.75 to about 6.5, and a water activity of about 0.3 to about 0.6.

In one exemplary embodiment, the meat crisps have a protein percentage of about 40% to about 75%. In another embodiment, the meat crisp have a protein percentage of about 60% to about 75%. In yet another approach, the meat crisps have a protein percentage of about 30% to about 60%.

In one illustrative embodiment, the meat crisps have a fat content of about 6% to about 30%. In another exemplary configuration, the crisps have a fat content about 6% to about 8%. In yet another example, the crisps have a fat content of about 25% to about 30%. The fat content, in another approach, is about 10% to about 20%.

In one illustrative approach, the meat crisps have a water activity in the range of about 0.4 to about 0.55. In another approach, the water activity is about 0.4 to about 0.5. In yet another example, the water activity is about 0.4 to 0.45. Another embodiment has a water activity of about 0.45 to about 0.55.

In one exemplary approach, the meat crisp has moisture percentage of about 4.5% to about 12%. In another approach, the moisture percentage is about 4.5% to about 10%. In yet another embodiment, the moisture percentage is about 4.5% to about 8%. The moisture percentage also may be about 4.5% to about 5.5%. Further, if a jerky-like chip is desired, as described below, the moisture percentage may be about 9% to about 11%. The moisture content, in another approach, is about 5% to about 15%. In still another configuration, the moisture percentage is about 4% to about 10%.

In one illustrative embodiment, the salt percentage is about 2% to about 7.5%. In another configuration, the salt percentage is about 5% to about 7.5%. The salt content, in another approach, is about 2% to about 5%.

In one illustrative example, the meat crisps have a pH of about 5.0 to about 6.5.

By one approach, each of the chips may have a homogenous composition of about 30% to about 60% protein, about 10% to about 20% fat, about 5% to about 15% moisture, about 0.3 to about 0.6 water activity, and about 2% to about 5% salt. Furthermore, the chips are generally contoured and have a first major dimension, such as a diameter, of about 0.5-in. to about 5.0-in. (about 12.7 mm to about 127 mm) and a thickness of about 0.025-in. to about 0.25-in. (about 0.635 mm to about 6.35 mm). As noted above, the meat crisp, in other embodiments, have a thickness of about 0.02-in. (about 0.508 mm) to about 0.04-in. (about 1.016 mm). In another illustrative approach, the meat crisp has a thickness of about 0.025-in (about 0.635 mm) to about 0.035-in. (about 0.889 mm). In yet another embodiment, the meat crisps have a thickness of about 0.03-in. (about 0.762 mm).

The chips, in one embodiment, may have a composition of about 6% to about 30% fat, about 40% to about 75% protein, a moisture percentage of about 4% to about 10%, less than 10% salt, a pH of about 5 to about 6.5, a water activity of about 0.4 to about 0.5, and a crispness value of less than 100 kg·seconds.

In some embodiments, the chips may include non-functional ingredients or inclusions, such as diced vegetables or cheese, or a small amount of starch. In another approach, however, the chip is free of inclusions and/or starch.

Further, the chips are crispy, having a crispness value of less than about 700 kg·seconds. More particularly, the chips have a break strength and a crispness that may be measured by compressing a stack of chips having a height of about 90 mm at a test speed of 1 mm/second through a distance of 50 mm in a cell frame, wherein the integral of the compressive force over 50 seconds of compression is less than about 700 kg·seconds, and wherein the standard deviation of the integral of force over 50 seconds of compression is less than about 110. In another embodiment, the integral of the compressive force over 50 seconds of compression is less than about 150 kg·seconds, and wherein the standard deviation of the integral of force over 50 seconds of compression is less than about 10. In yet another embodiment, the integral of the compressive force over 50 seconds of compression is between about 50 and about 150 kg·seconds. The integral of the compressive force over 50 seconds of compression may be about 80 to about 125 kg·seconds and the standard deviation of the integral of force over 50 seconds of compression is less than about 7. In another approach, the crispness value is less than about 100 kg·seconds. By yet another approach, the crispness value is less than about 60 kg·seconds. One illustrative embodiment has a crispness value of about 35 kg·seconds to about 60 kg·seconds.

By one approach, the meat crisp is produced by preparing a formula or raw meat material, mixture, or batter having a ground or comminuted raw meat and added, non-meat ingredients. The ground meat may have a particle size in a range of about 0.0625-in. to about 0.5-in. (about 1.59 mm to about 12.7 mm). The raw meat material is mixed and stuffed into casings or molds and then thermally processed. Thereafter, the cooked meat logs are then cooled and possibly frozen before slicing the cooled meat log into slices having a thickness of between about 0.01-in. (about 0.254 mm) to about 0.25-in. (about 6.35 mm). In one illustrative approach, the meat slices (before the dehydration step) have a thickness of between about 0.040-in. (about 1.016 mm) to about 0.06-in. (about 1.524 mm). In another approach, the meat slices will have a thickness of about 0.04-in. (about 1.016 mm) to about 0.05-in. (about 1.27 mm). In another embodiment, the meat slices will have a thickness of about 0.045-in. (about 1.143 mm). In yet another embodiment, the meat slices will have a thickness of about 0.05-in. (about 1.27 mm). After slicing the meat log, the slices are then dehydrated to create a meat crisp having a thickness of about 0.05-in. (about 1.27 mm) to about 0.1-in. (about 2.54 mm) and a moisture range of about 5% to about 15%. In one illustrative approach, the meat crisp has a thickness of about 0.02-in. (about 0.508 mm) to about 0.04-in. (about 1.016 mm). In another illustrative approach, the meat crisp has a thickness of about 0.025-in (about 0.635 mm) to about 0.035-in. (about 0.889 mm). In one embodiment, the meat crisps have a thickness of about 0.03-in. (about 0.762 mm).

In another illustrative process, the raw meat mixture is prepared, mixed, and then portioned or sheeted into thin, raw meat films or sheets having a thickness of about 0.01-in. (about 0.254 mm) to about 0.25-in. (about 6.35 mm). In another embodiment, the sheets or films have a thickness of about 0.039-in. (about 1 mm) to about 0.118-in. (about 3 mm). Another approach sheets or portions meat films having a thickness of 0.039-in. (about 1 mm) to about 0.0787-in. (about 2 mm). These raw meat films are then thermally processed and/or dehydrated into meat crisps having a crisp thickness of 0.05-in. (about 1.27 mm) to about 0.1-in. (about 2.54 mm) and a moisture range of about 5% to about 15%. In another configuration, the meat crisps, after portioning into thin sheets, cooking, and dehydrating, have a thickness of about 0.02-in. (about 0.508 mm) to about 0.04-in. (about 1.016 mm). In another illustrative approach, the meat crisp has a thickness of about 0.025-in (about 0.635 mm) to about 0.035-in. (about 0.889 mm). In one embodiment, the meat crisps have a thickness of about 0.03-in. (about 0.762 mm).

The meat crisps described herein generally have a crunchy or crispy texture, similar to a potato or corn chip. Some meat crisps described herein have an eating quality or mouthfeel that starts like a crunchy chip and finishes like a chip, such that the meat crisp is worked down in the mouth like a potato chip that begins to fully break down or disintegrate. Other meat crisps described herein may have an eating quality or mouthfeel that starts like a crunchy chip and finishes like a meat jerky, such that the meat crisp is worked down gradually and does not dissolve like a potato chip or form a bolus. In this manner, the meat crisp may develop a chewiness that resembles a meat jerky during mastication, after the product has absorbed or taken on moisture from the consumer. Depending on the desired final meat crisp product, the meat batter (including the moisture content and water activity of the batter) may be adjusted to provide the desired meat product. Further, the process, such as the dehydration process, also may be adjusted to produce the desired meat crisp.

For example, for a meat crisp that becomes chewier, like a jerky, after an initial crunchy mouthfeel, the composition may include a protein percentage of about 40% to about 45%, a fat percentage of about 10% to about 20%, a moisture percentage of about 10%, a water activity in the range of about 0.5 to about 0.52, a pH of about 5 to about 6, and a crispness value of about 100 to about 105 kg·seconds. Further, the meat crisps also may include some added starch, such as about 1.0% or about 1.5% of the formula, though the meat crisps, including crisps that become chewier during mastication, also may be produced without starch, as noted below.

By way of another example, for a meat crisp that maintains its chip-like texture during mastication, the composition may include about 60% to about 75% protein, a fat range of about 6% to about 30%, a moisture percentage of about 4% to about 5%, a water activity of about 0.4, a pH of about 0.6, and a crispness value of less than about 100 kg·seconds.

In regard to the raw meat mixture, in one embodiment, the mixture comprises about 30% added water, about 5% added, non-meat ingredients, and about 65% meat product. In another approach, the raw meat mixture includes about 5% added water, about 2% added, non-meat ingredients, and about 93% meat product.

### BRIEF DESCRIPTION OF THE DRAWINGS

FIG. 1 comprises a process for producing a meat crisp;

FIG. 2 comprises an alternative process for producing a meat crisp;

FIG. 3 comprises a perspective view photograph of a meat crisp (held in position with beeswax) produced in accordance with the disclosure herein;

FIG. 4 comprises a side view photograph of the meat crisp of FIG. 3;

FIG. 5 comprises a front view photograph of the meat crisp of FIG. 3;

FIG. 6 comprises a schematic diagram of two meat crisps in accordance with a first embodiment;

FIG. 7 comprises a schematic diagram of two meat crisps in accordance with a second embodiment;

FIG. 8 comprises a schematic diagram of two meat crisps in accordance with a third embodiment;

FIG. 9 comprises a schematic diagram of two meat crisps in accordance with a fourth embodiment;

FIG. 10 is a graph illustrating results from a texture test;

FIG. 11 is a graph illustrating the results from texture tests of a variety of products.

### DETAILED DESCRIPTION

A meat chip or crisp 10 having a crunchy and crispy texture, mouth feel, and taste and processes for producing such crisps are provided herein. In one example, the chip or crisp 10 has an appearance, texture, flavor, eating quality, and/or mouth feel similar to those of a conventional snack chip, such as a potato chip or corn chip. Instead of being primarily comprised of a fried potato slice or fried cornmeal, the proteinaceous meat crisp 10 is primarily comprised of meat. The meat crisp 10 may be seasoned or unseasoned. The processes described herein can be employed to produce the meat crisp 10 from a combination of meat and added, non-meat ingredients including added water. In some embodiments, the meat crisp 10 can be stored at ambient or refrigerated temperatures.

As noted above, conventional meat snacks typically have a texture and mouth feel that is somewhat chewy, leathery, or tough. Meat crisp 10 typically has a rigid, non-deformable, or stiff structure that suddenly collapses with a brittle fracture and a rapid decay of force after fracture, as defined by a mechanical snap test. Further, the meat crisp 10 typically has a low or very low shear strength and breaks under compression with very little grinding, rapidly breaking into small pieces. The meat crisp 10 typically has a low-to-medium level of chewiness and low-to-medium work content for mastication. The meat crisp 10 typically has a sound associated with the brittle fracture with a range of sound intensity over time when masticated, and a characteristic frequency pattern. As noted above, the meat crisps described herein may retain their chip-like mouthfeel until completely swallowed such that the meat crisp starts and finishes similar to a potato chip. Alternatively, the meat crisps described herein may have an initial mouthfeel like a crunchy chip, such that the first few bites provide a crispy, potato chip-like mouthfeel that then gives way to a chewier, jerky-like mouthfeel. Either way, the meat crisp 10 provides an initial mouthfeel that is crunchy and crispy in texture.

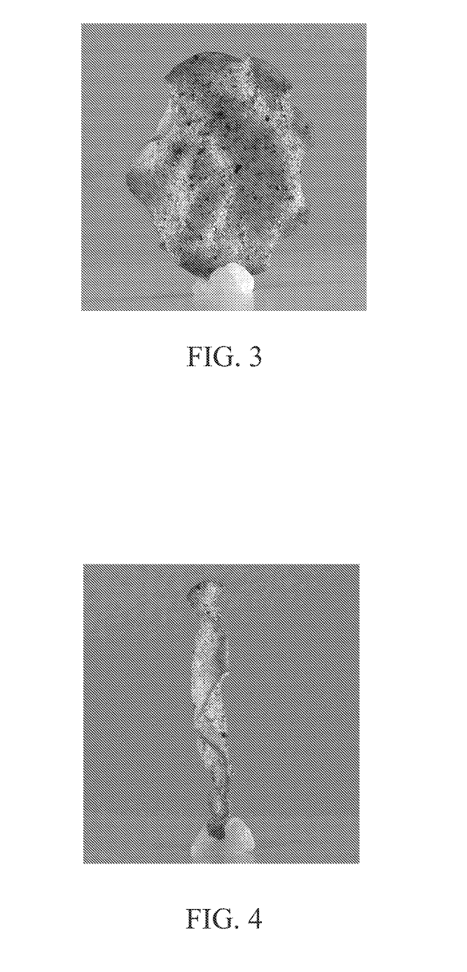

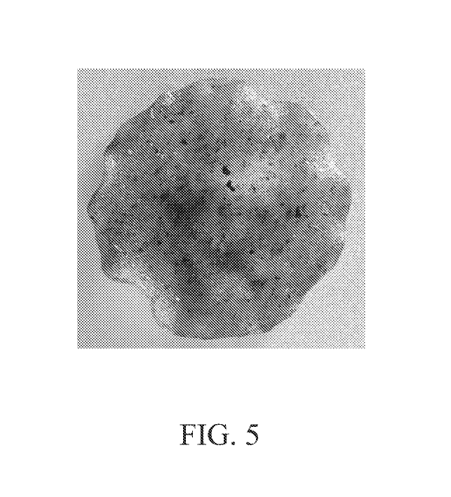

As illustrated in FIGS. 3-5, the meat chip or crisp 10 has an appearance that may be characterized by, but not limited to, waviness on the edges of the crisp, a level of translucency, and an overall chip-like appearance. In other configurations, the meat crisps may have a more irregular shape and may include some darker or opaque portions as well. For example, for meat crisps primarily comprised of pork or beef, the appearance may have less translucency and more opaqueness than illustrated in FIGS. 3-5. The crisp 10 has a pair of opposing sides and each of the discrete meat crisps is easily graspable by a consumer. The crisp 10 can have a circle-, square-, rectangular-, strip-, triangular-, or oval-shape, among others. Furthermore, the meat crisp 10 generally has a thickness of about 0.025-in. to about 0.25-in. (about 0.635 mm to about 6.35 mm). By one approach, the meat crisp 10 has a thickness of about 0.05-in. to about 0.1-in. (about 1.27 mm to about 2.54 mm). In another illustrative approach, the meat crisp has a thickness of about 0.02-in. (about 0.508 mm) to about 0.04-in. (about 1.016 mm). One embodiment has a thickness of about 0.025-in (about 0.635 mm) to about 0.035-in. (about 0.889 mm). In yet another embodiment, the meat crisps have a thickness of about 0.03-in. (about 0.762 mm). The meat crisps also may have slightly thicker edges and be slightly thinner in the middle.

The meat crisp 10 may have a water activity (A_{w}) of about 0.3 to about 0.6. By one approach, the meat crisp has a water activity of about 0.4 to about 0.55. By another approach, the meat crisp has a water activity of about 0.45 to about 0.55. One embodiment has a water activity of about 0.4 to about 0.45. In still another approach, the meat crisp has a water activity of about 0.4 to about 0.5.

Further, the meat crisp 10 may have a moisture percentage of about 4% to about 15%. One embodiment has a moisture percentage of about 4.5% to about 12%. By another approach, the meat crisp 10 may have a moisture percentage of about 5% to about 15%. In another embodiment, the moisture range is about 8% to about 12%. By another approach, the meat crisp may have a moisture percentage of about 4.5% to about 10%. Another embodiment includes a moisture percentage of 4.5% to about 8%. In one example, the moisture percentage is about 4.5% to about 5.5%. Further, if a jerky-like chip is desired, the moisture percentage may be about 9% to about 11%.

The meat crisp 10 may have a fat percentage of less than about 30%. In another configuration, the meat crisp 10 may have a fat percentage of about 6% to about 30%. In yet another approach, the meat crisp 10 may have a fat percentage of about 10% to about 20%. In one example, the fat percentage is about 14% to about 18%. In another exemplary configuration, the crisps have a fat content about 6% to about 8%. In yet another example, the crisps have a fat content of about 25% to about 30%.

The meat crisp 10 may have a protein content of about 30% to about 75%. In one illustrative example, the meat crisp 10 may have a protein content of about 30% to about 60%. In another embodiment, the meat crisp 10 may have a protein content of about 40% to about 75%. By another approach, the meat crisp has a protein percentage of about 40% to about 50%. One illustrative embodiment has a protein percentage of about 60% to about 75%.

The meat crisp 10 may have a salt content of about 10% or less. In one embodiment, the meat crisp has a salt content of about 2% to about 7.5%. The meat crisp 10 may have a pH of about 4.75 to about 6.5, and, in one approach, has a pH of about 5.0 to about 6.0. By another approach, the meat crisp 10 has a pH of about 5 to about 6.5.

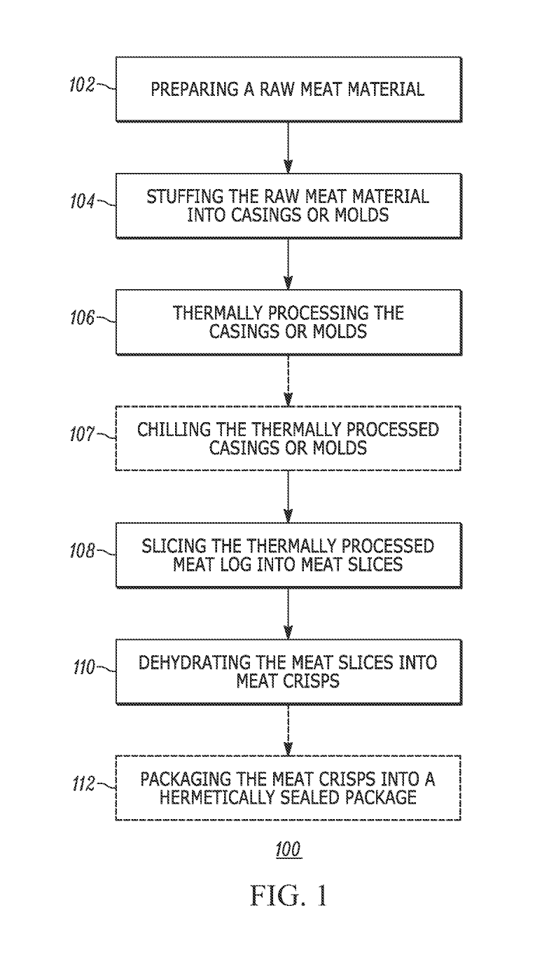

FIG. 1 shows an illustrative process 100 that can be used to form the meat crisps 10. Process 100 starts with preparing 102 a formula, raw material, or batter including meat, such as turkey, chicken, beef, or pork, among others. The raw meat may be chopped, ground, or comminuted to form it into a meat emulsion, a finely ground meat, or a comminuted meat. In one approach, the raw meat is ground through a plate with openings therein. The openings may have a variety of sizes and the resulting meat particles or pieces may vary accordingly. By one approach, the raw meat may have a particle size of between about 0.0625-in. to about 0.5-in. (about 1.59 mm to about 12.7 mm). In one illustrative approach, the raw meat has a particle size of about 0.078-in. to about 0.188-in. (about 1.98 mm to about 4.78 mm).

Alternatively, the formula or raw material may include whole muscle portions. For example, in one illustrative embodiment, the step of preparing 102 the raw material may include mixing whole muscle meat pieces in a whole muscle batter with the added ingredients. The whole muscle meat pieces or portions are generally intact muscle fibers, and not ground or emulsified. These whole muscle meat portions can be macerated and injected with brine prior to mixing into the formula or raw material. In one illustrative approach, the raw material includes less than about 15% emulsified meat. In another approach, the raw formula includes less than about 8% of emulsified meat. One illustrative approach includes less than about 5% of emulsified meat. In yet another illustrative approach, the raw material is free of emulsified meat.

In addition to the meat, the formula also may include added ingredients, such as flavorings, including spices or inclusions, binders, water, and food safety or antimicrobial ingredients. By one approach, the added, non-meat ingredients can include, for example, spices or seasonings, such as garlic, onion, pepper, etc., broth, such as chicken, beef, turkey, or pork broth, potato starch, coloring such as caramel color, sodium chloride (salt), potassium chloride, dextrose, oleoresin, paprika, corn syrup, and inclusions such as cranberries, garlic, onion, pepper, and cheese, among others. The binders added to the raw material may include, for example, corn starch, tapioca starch, potato starch, rice flour, konjac flour, and other ingredients used to increase viscosity and water retention. Though starches may be incorporated into the formula, in one illustrative embodiment, the formula remains starch free. The food safety ingredients may include, for example, sodium nitrite, antimicrobials, such as sodium diacetate, sodium or potassium lactate, sodium propionate, sodium phosphate, sodium benzonate, sodium acetate, and sodium citrate, and other natural (not artificial) preservatives, such as acerola powder, celery juice, celery powder plus a lactic acid starter culture, cultured dextrose, vinegar, cultured sugar, lemon juice solids, rosemary, nisin, micocin, and other cultures from fruits and vegetables and other natural preservatives, among others. In addition to the non-meat ingredients listed above, non-meat protein may also be incorporated into the meat crisp. For example, milk or vegetable protein could be used in addition to fish or shell-fish.

In some embodiments, the formula that is mixed for the raw material in process 100 may include about 60% to about 95% meat and less than about 40% of added non-meat ingredients. If the water is separated from the remainder of the added, non-meat ingredients, the formula may include about 60% to about 95% meat, less than about 10% added, non-meat ingredients besides water, and about 5% to about 30% added water. By one approach, the percentage of added, non-meat ingredients (including water) will be in the range of about 10% to about 25%. Once mixed, the raw material may have a moisture content of about 40% to about 90%, fat content of about 0.1% to about 15%, and a protein content of about 10% to about 40%. In one illustrative embodiment, the raw material has a moisture content of about 65% to about 85%, a fat content of about 1% to about 10%, and a protein content of about 15% to about 30%.

Preparing 102 the raw material also may include mixing the ingredients. By one approach, the raw material is mixed for about 5 minutes to about 120 minutes. In one illustrative embodiment, the raw material may be made in batches of about 100 lbs. to about 20,000 lbs. Further, the mixer for the raw material may operate at between about 5 to about 100 RPM.

Process 100 further includes stuffing 104 the raw material or meat batter into casings to produce a meat log. The casings used with process 100 may include, for example, cook-in-bag casings, fibrous casings, edible casings, cellulose casings, and stainless steel molds, among other casings or molds used to stuff and contain meats. By one approach, the casings typically have a diameter of about 2-in. to about 6-in. (about 50.8 mm to about 152.4 mm). The casings may have a variety of shapes, such as, for example, a circle-, ellipse-, and D-shape, among others. Further, the casings or molds may have a length of about 5-in. to about 80-in. (about 12.7 cm to about 203.2 cm). In another approach, the stuffing 104 of process 100 may not use casings or molds, but may be processed casingless. For example, if the raw material or meat batter is sufficiently stiff, it may not require a casing or mold. In this case, the raw material or meat batter is advanced into and through the stuffing machine thereby forming it into a meat log. Instead of discharging the meat log into a casing, however, a casingless process relies on the raw material or batter being sufficiently stiff to thereby hold or retain its shape without the aid of a casing or mold.

After the raw material has been stuffed 104 into a raw meat log, the process 100 continues with thermal processing 106 of the raw material or meat batter. As used herein, thermal processing is used to achieve at least a partial or full pathogenic kill. In another approach, the thermal processing step also is used to at least partially shape the product in the casing or mold. In one illustrative embodiment, the thermal or cook process uses a conventional smokehouse or water cook tanks. Depending on the desired final product, the thermal process 106 may include a smoking step. The thermal process 106 may have a cook length in a range of about 30 minutes to about 600 minutes. Thermal processing 106 may occur in a series of steps or temperatures. For example, the steps may have a dry bulb range of about 90° F. to about 200° F. and a wet bulb range of about 150° F. to about 200° F.

After thermal processing 106, the process 100 may include cooling or chilling 107 the cooked meat log. The chilling step 107 may have a length in a range of about 30 minutes to about 600 minutes. As discussed herein, the chilling process may incorporate a cooler, a cold water shower, cold brine, a spiral freezer or cooler, or a blast cell, among others. Though the meat log may have a bit of incidental water loss during the chilling step 107, this is distinct from the dehydration step 110 described further below. If there is any incidental water loss during the chilling step 107, it would be less than about 3% water loss, by weight. Water loss also may occur during the cooking process 106, as discussed below.

After the meat log has been thermally processed 106, the meat log is sliced 108 into meat slices. Further, the cooked meat slices may have a thickness in a range about 0.01-in. to about 0.25-in. (about 0.254 mm to about 6.35 mm). In other configurations, the cooked meat slices have a thickness of about 0.025-in. to about 0.25-in. (about 0.635 mm to about 6.35 mm). By yet another approach, the cooked meat slices have a thickness of about 0.075-in. to about 0.15-in. (about 1.9 mm to about 3.81 mm). As noted above, in one illustrative approach, the meat slices (before the dehydration step) have a thickness of between about 0.04-in. (about 1.016 mm) to about 0.06-in. (about 1.52 mm). In another approach, the meat slices will have a thickness of about 0.04-in. (about 1.016 mm) to about 0.05-in. (about 1.27 mm). In another embodiment, the meat slices will have a thickness of about 0.045-in. (About 1.143 mm). In yet another embodiment, the meat slices will have a thickness of about 0.05-in. (about 1.27 mm). The temperature of the slicing operation may occur in a range of about 0° F. to about 45° F. At this point, the proteins have been denatured and the meat log and meat slices are ready to eat, however, process 100 continues to produce meat crisps, as opposed to merely producing cooked meat. In regards to the slicing equipment, a variety of slicers are contemplated including automated slicers, hand slicers, or other commercially available slicers. Slicers that may be used with the processes described herein consistently deliver a meat slice with uniform thickness. Though process 100 indicates that the thermal processing step 106 occurs before the meat log is sliced, in another approach, the meat log may be sliced before thermal processing. For example, the meat log may be partially frozen and/or extruded to enable slicing.

The meat logs in process 100 may have a variety of diameters. In one illustrative approach described herein, the meat log had a stuffed diameter of about 3.15-in. (about 80 mm) and a flat width of about 4.72-in. (about 120 mm). In one exemplary approach, about 10 slices of meat (pre-dehydration) will include about 65-70 grams of meat product, if the meat log has a stuffed diameter of about 3.15-in.

After the meat log is sliced, the process 100 includes a dehydration process or step 110 such that the cooked meat slices are dehydrated into meat crisps. This is in addition to any attendant dehydration or water loss that may occur during the cooking or chilling processes. The dehydration step 110 may include for example, microwave cooking, radio frequency treatment, convection heating, infrared treatment, heat pump drying, modified atmosphere heat pump drying, vacuum drying, and freeze drying, among others. In addition, these (and other) drying technologies may be used together in a combined dehydration process. For example, the dehydration step 110 may be a multi-stage, hybrid or combination of drying technologies. Further, while more conventional chips are often fried in oil or shortening, the dehydration step 110 does not involve frying the meat slices. By one approach, the dehydration process 110 may occur for about 30 to about 600 minutes. In one illustrative example, the dehydration process 110 is about 480 minutes. In yet another approach, such as a microwave-based approach, the dehydration may occur for less than about four minutes or less than about two minutes.

While the thermal process 106 may result in water loss during cooking, this is typically in a range of about 5% to about 15% for fibrous casings. Further, the main purpose of the thermal processing 106 is to cook (i.e., achieve at least a partial or full pathogenic kill) the meat, and the resulting water loss is generally equivalent to about the amount of added water or less than the amount of added water, though this can depend on the casing. For example, if the thermal processing step 106 employs a cook-in-bag technology it may result in no water loss because the casing is typically impermeable.

The dehydration step 110, on the other hand, will typically result in a water loss of about 45% to about 80%. By one approach, the dehydration step 110 will result in a water of loss of about 50% to about 70%. The main purpose of the dehydration step 110 is to remove sufficient water from the meat slice to form a crispy, crunchy meat crisp. During the dehydration step 110, the water that is native to the meat or meat log is removed from the meat slice. If water is added to the meat batter, it will be lost as well, most likely before the bound or native water associated with the muscle fibers is lost. Thus, in one illustrative step, the water that is added to the meat batter is previously lost during the thermal processing step, and the water that is lost in the dehydration step is the water that is native to the meat.

Further, the thermal process 106 may have a combination of wet and dry bulb steps or settings to cook the meat, which results in the process having a higher overall relative humidity. The dehydration process 110, however, typically has a much lower relative humidity such that the dehydration process 110 consists primarily of dry heat.

After the dehydration step 110, the dehydrated meat crisps may have a thickness of about 0.025-in. (about 0.635 mm) to about 0.25-in. (6.35 mm). In one illustrative configuration, the meat crisps have a thickness of about 0.029-in. to about 0.034-in. The thickness of exemplary meat crisps was measured and, in one sample, the meat crisps had a thickness of 0.029-in. with a standard deviation of +/−0.003-in. In another sample, the meat crisps had a thickness of 0.034-in. with a standard deviation of +/−0.002-in. By way of comparison, Tostitos® potato chips generally have a thicknesses of 0.05-in. to 0.08-in., Lay's® Classic potato chips generally have a thicknesses of 0.031-in. to 0.037-in., and Pringles® potato chips generally have a thickness of 0.035-in. to 0.045-in.

In yet another configuration, the meat crisps have a thickness of about 0.05-in. (about 1.27 mm) to about 0.1-in. (about 2.54 mm). Thus, if the cooked meat slices have a thickness of about 0.075-in. to about 0.15-in. (1.9 mm to about 3.81 mm) after slicing 108, but then have a meat crisp thickness of about 0.05-in. (about 1.27 mm) to about 0.1-in. (about 2.54 mm) after the dehydration step 110, a notable amount of product size is lost. In this manner, in addition to facilitating the crispy texture and mouth feel of the meat crisp, the dehydration process also results in a loss of water that reduces the overall size and volume of the product. For example, the meat crisps may experience a size shrinkage or a loss of dimension of about 0.25-in. to about 1.75-in. (about 6.35 mm to about 44.45 mm) during the dehydration process (i.e., from their size after slicing to their size after the dehydration process). In one embodiment, the dimension loss during dehydration is about 1.0-in. to about 1.25-in. (about 25.4 mm to about 31.75 mm). Further, the meat crisps may experience a volumetric loss or shrinkage of about 65% to about 95%. By one approach, the meat crisps experience a volumetric loss or shrinkage of about 75% to about 85% during the dehydration process.

The process 100 also may include packaging 112 the dehydrated meat crisps into a hermetically sealed package, container, or pouch. In one illustrative embodiment, the packaging 112 occurs under a modified atmosphere such that the residual oxygen level is about 0.01% to about 5%. By one approach, the package may include a flexible pouch, gusseted bag, or rigid tray, among others. Furthermore, in some embodiments, the package may be comprised of film, foil, plastic, metalized film, and/or paperboard, among other materials. The meat crisps described herein may be packaged in single-serve or multi-serve containers. For example, if a serving size is 10-20 chips, the package may include about that many meat crisps or may include many more meat crisps. The packaging 112 may optionally incorporate oxygen scavengers within the package. In addition to oxygen scavengers, the package may incorporate moisture scavengers as well. Further, depending on the package design, it may include a peg hole or a stand-up feature, among other features that consumers or grocers may find desirable. Further, given the product's qualities, the film structure may require significant moisture, oxygen, and light barrier properties to help prevent staling and oxidative rancidity from occurring.

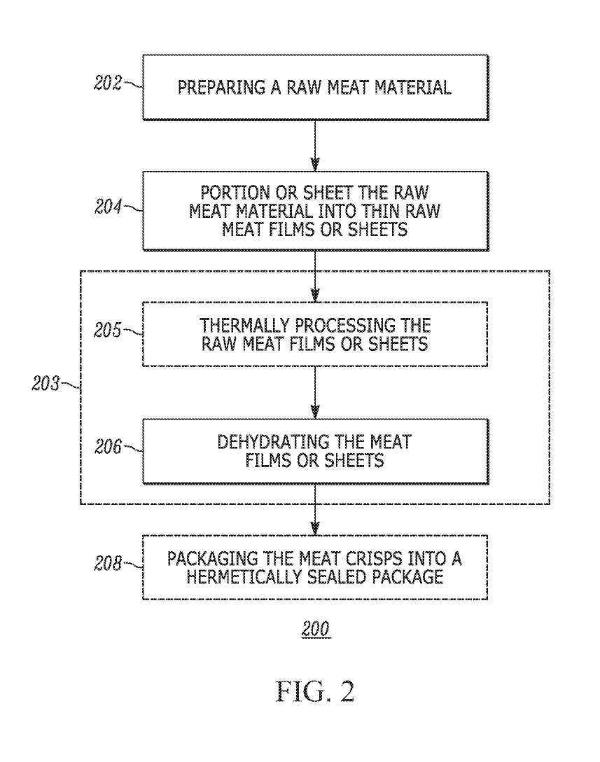

Another illustrative process 200 is shown in FIG. 2. Process 200 is similar to process 100, except that process 200 does not stuff the raw material into casings or molds where the meat is thermally processed. The raw material is prepared 202, similar to process 100. The raw meat may be chopped, ground, or comminuted to form it into a meat emulsion, a finely ground meat, or a comminuted meat. For example, the raw meat may have a particle size of between about 0.0625-in. to about 0.5-in. (about 1.59 mm to about 12.7 mm). In one illustrative approach, the raw meat has a particle size of about 0.078-in. (about 1.98 mm) to about 0.188-in. (about 4.78 mm). In yet another, illustrative approach, the raw meat has a particle size of about 0.0625-in. (about 1.66 mm) to about 0.078-in. (about 2.0 mm). One configuration generally includes raw meat with a particle size of about 0.0625-in. (about 1.66 mm). In yet another configuration the raw meat has a particle size of about 0.078-in. (about 2.0 mm). In addition to the raw meat, preparing 202 the formula or raw material includes adding the non-meat ingredients discussed above, such as flavorings, including, for example, spices or inclusions, binders, water, and food safety or antimicrobial ingredients. When employing the sheeting process 200, the raw material that is prepared 202 may have the appearance of a meat dough such that it has a viscosity and moisture content of similar consistency and manageability as dough used in a commercial bakery setting.

Further, as noted above, the formula may include about 60% to about 95% meat and less than about 40% of added non-meat ingredients. If the water is separated from the remainder of the added, non-meat ingredients, the formula may include about 60% to about 95% meat, less than about 10% added, non-meat ingredients besides water, and about 5% to about 30% added water. By one approach, the percentage of added, non-meat ingredients (including water) will be in the range of about 10% to about 25%. Once mixed, the raw material may have a moisture content of about 40% to about 90%, fat content of about 0.1% to about 15%, and a protein content of about 10% to about 40%. In one illustrative embodiment, the raw material has a moisture content of about 65% to about 85%, a fat content of about 1% to about 10%, and a protein content of about 15% to about 30%.

The preparation 202 of the raw material may include mixing the ingredients for about 5 minutes to about 120 minutes in a mixer operating at about 5 to about 100 rpm. As noted above, the batch size can be between about 100 lbs. to about 20,000 lbs.

As opposed to stuffing 104, the process 200 portions or sheets 204 the raw meat material or batter into a thin film, patty, or sheet. This can occur via a continuous belt or other system. Further, the meat may be deposited into a mold or volumetric dispenser or extruded or advanced through other systems with capacity to form the thin, raw meat films or sheets. In one illustrative approach, the portioning or sheeting 204 forms meat films having a thickness of about 0.039-in. (about 1 mm) to about 0.118-in. (about 3 mm). In another configuration, the portioning or sheeting 204 forms meat films having a thickness of about 0.039-in. (about 1 mm) to about 0.0787-in. (about 2 mm).

After the raw meat films or sheets are formed or portioned 204, the process 200 may include either a combination thermal process and dehydration step 203 or a thermal processing step 205 and a separate dehydration step 206.

If a combination thermal process and dehydration step 203 is employed, the process may include conventional smokehouse cooking, microwave cooking, radio frequency treatment, convection heating, infrared treatment, heat pump drying, modified atmosphere heat pump drying, vacuum drying, and freeze drying, among others. In addition, these (and other) drying technologies may be used together in a combined dehydration process. For example, the combination step 203 may be a multi-stage, hybrid or combination of drying technologies. Also, the combination step 203 may include an optional smoking step, if desired for the final product. The combination process 203 may include a cooking or heating process and a potential cooling or chilling process. Both such processes may occur for about 30 minutes to about 600 minutes. If a combination step 203 is employed, the dehydration occurring will result in a loss of water added to the formula and water native to the meat. Further, the process 200 may occur continuously such that the meat sheets are continuously advanced from thermal processing equipment to dehydration equipment. In such a configuration, the cooling may occur when the products are exposed to ambient air while being moved on conveyors.

If separate processes are employed, the thermal process 205 may occur, for example, in a conventional smokehouse. As suggested above, in another configuration, the thermal process 205 occurs in a continuous cook process that may employ a number of ovens. Further, the thermal processing 205 of the sheets may include an optional smoking step, depending on the desired final product. As noted above, the thermal processing 205 may include cooking and chilling steps, which each may occur for about 30 minutes to about 600 minutes. Further, the separate dehydration step may include, for example, microwave cooking, radio frequency treatment, convection heating, infrared treatment, heat pump drying, modified atmosphere heat pump drying, vacuum drying, and freeze drying, among others. In addition these and other drying technologies may be used together. By one approach, the dehydration step 206 is a multi-stage, hybrid or combination of drying technologies. If separate thermal processing 205 and dehydration steps 206 are employed, the degree of dehydration attendant each process is similar to that discussed above with respect to process 100. The dehydration step 206 may occur for about 30 to about 600 minutes. In one illustrative example, the dehydration step occurs for about 480 minutes. In yet another approach, such as a microwave-based approach, the dehydration may occur for less than about four minutes or less than about two minutes.

The process 200 also may include packaging 208 the dehydrated meat crisps into a hermetically sealed package, container, or pouch. In one illustrative embodiment, the packaging 208 occurs under a modified atmosphere such that the residual oxygen level is about 0.01% and about 5%. By one approach, the package may include a flexible pouch, gusseted bag, or rigid tray, among others. Furthermore, in some embodiments, the package may be comprised of, for example, film, foil, plastic, metalized film, and/or paperboard, among other materials. The meat crisps described herein may be packaged in single-serve or multi-serve containers. For example, if a serving size is 10-20 chips, the package may include about that many meat crisps or may include many more meat crisps. The packaging 112 also may incorporate oxygen scavengers within the package. In addition to oxygen scavengers, the package may incorporate moisture scavengers as well. Further, depending on the package design, it may include a peg hole or a stand-up feature, among other features that consumers or grocers may find desirable. Further, given the product's qualities, the film structure may require significant moisture, oxygen, and light barrier properties to help prevent staling and oxidative rancidity from occurring.

Whether the meat crisp 10 is produced according to process 100 or process 200, the resulting product is a meat crisp with a crunchy and crispy texture. In some embodiments, the product can be stored at ambient temperatures. In other embodiments, the product can be stored at refrigerated temperatures. In either case, the meat crisp has a shelf stable life of e.g., at least 30 days, at least 60 days, at least 90 days, at least 120 days, at least 150 days, or at least 180 days, during which it retains the desirable organoleptic properties described above. Further, the meat crisp described herein has a mouth feel, appearance, texture, flavor, and eating quality of a conventional snack chip. The meat crisp has a rigid, non-deformable, and stiff structure that suddenly collapses with brittle fracture and a rapid decay of force after fracture. The meat crisp has low or very low shear strength, breaks up under compression with little grinding, and rapidly breaks into small pieces.

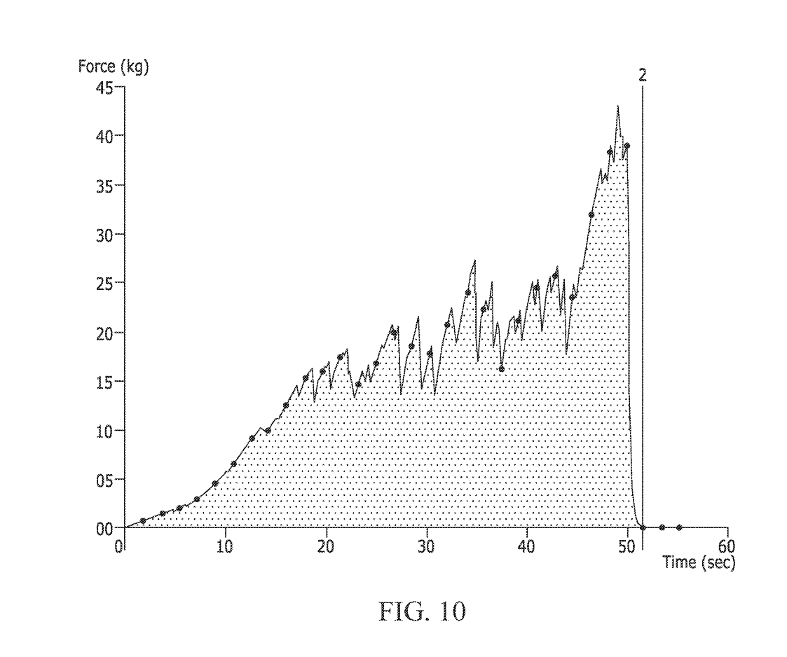

To measure the crispness of the meat chip, a texture test was performed on the Ottawa texture cell frame (TAXT2 plus texture analyzer) with a square piston. For the test, the chips were stacked up to the top of the cell (90 mm in height) and compressed at a speed of 1 mm/second through a distance of 50 mm. The values of force and time were plotted and the area under the curve was used as a measure of crispness. Stated another way, the area under the curve (force versus time) represents the toughness of the material. Accordingly, the less tough materials are generally crispier. The results of one such meat crisp texture test are illustrated in FIG. 10. The texture test results illustrated in FIG. 10 were gathered using the texture test described herein. The y-axis denotes the force in kilograms and the x-axis denotes the distance in seconds. The plunger or piston is advanced at a test speed of 1 mm per second. Further, the area under the curve represents the hardness work or toughness of the material. Whereas the sensory definition of hardness work is the work necessary to overcome the internal strength of the bonds within the food, the mathematical description is the area under the load versus distance curve from the cycle start down to the target value.

As illustrated in the chart below showing the results of several texture tests, the meat crisps 10 are generally crisper than several other chips that were tested. The chip tested having the closest crispness to the meat chips was the Lay's® Classic Potato Chip.

| | Average of | Standard | |
|---|---|---|---|
| | Positive Area | Deviation of | |
| Product | (kg · s) | Positive Area | COV |
| Athenos ® Pita Chips | 731 | 103 | 14.1% |
| Fritos ® Corn Chips | 727 | 69 | 9.5% |
| Lay's ® Classic Potato | 149 | 22 | 15.0% |
| Chip | | | |
| Meat Crips Batch 1 | 84 | 6 | 6.7% |
| Meat Crips Batch 2 | 120 | 2 | 1.6% |
| Miss Vickie's ® Jalapeno | 308 | 39 | 12.7% |
| Flavored Potato Chip | | | |
| Tostitos ® Restaurant Style | 391 | | |
| Tortilla Chips | | | |

The results showed were generally consistently reproducible. The coefficient of variation (CV) supports the reproducibility of the data. Though a 15% coefficient of variation was found to be typical among crispy products. The meat crisps that were tested have a coefficient of variation of about 1.6% to about 6.7%. Further, the consistency in shape and dimension aid with the reproducibility of this method.

The crispness value or the area under the force versus time curve or function is given in kilogram. seconds (kg.sec). The meat crisps had a crispness value of 84 kg·sec and 120 kg·sec, well below the crispness value of the other tested chips. Meat crisps batch 1 and batch 2 were prepared with the same formulation and the process 100 described above. Thus, the meat crisps are notably crispier than their conventional chip counterparts.

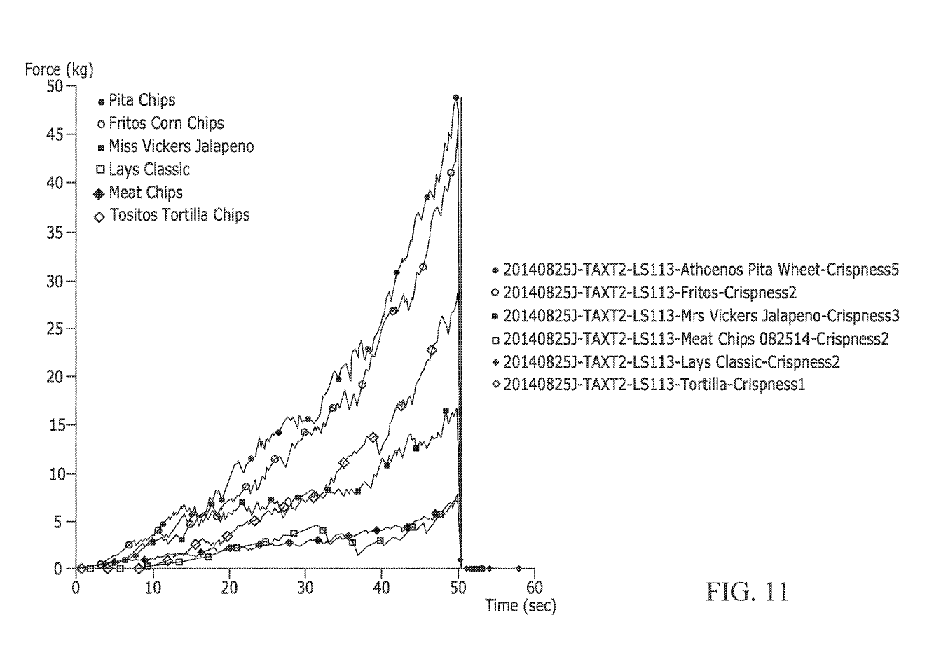

FIG. 11 illustrates the texture results of the test described above. The Athenos® Pita Chips (denoted by a solid circle) has the highest area below the curve or line on the graph. The line representing the Lay's® Classic Potato Chip (denoted by a solid diamond) is the most similar to the meat crisp batch 2 (denoted by an empty square), though the average of area below the curve or line representing the meat crisp is lower than the Lay's® Classic Potato Chip, as further illustrated above in the table.

FIGS. 3-5 illustrate one exemplary meat crisp 10 that has wavy edges with a generally sinusoidal, undulating, or rippling configuration. The crisps described herein generally have a thickness of about 0.025-in. to about 0.25-in. (about 0.635 mm to about 6.35 mm). In one illustrative approach, the meat crisp has a thickness of about 0.02-in. (about 0.508 mm) to about 0.04-in. (about 1.016 mm). In another illustrative approach, the meat crisp has a thickness of about 0.025-in (about 0.635 mm) to about 0.035-in. (about 0.889 mm). In one embodiment, the meat crisps have a thickness of about 0.03-in. (about 0.762 mm). Further, the crisps 10 have a center portion that is somewhat flat or gently rolling. Indeed, though the edges of the crisps 10 have a wavy configuration, the crisps 10 generally retain the shape or configuration created prior to thermal processing. For example, crisps 10 having a generally circular configuration have generally retained this configuration during dehydration such that the final product received by consumers will have a generally circular configuration. On the other hand, if the prepared slices, films, or sheets have another shape, such as a triangular, rectangular, or square, among others, the dehydrated crisps will retain such a shape.

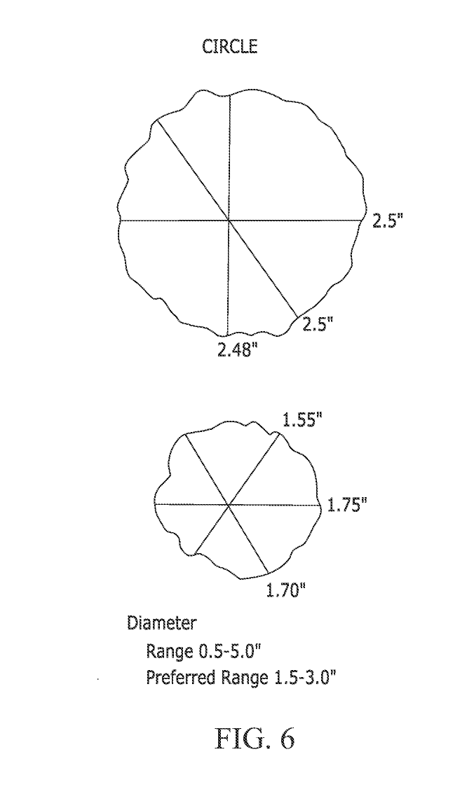

FIG. 6 illustrates two meat crisps 20 and 30 that may be produced according to the processes described herein. The crisps 20, 30 have a generally circular configuration with a diameter of about 0.5-in. to about 5.0-in. (about 12.7 mm to about 127 mm). By one approach, the meat crisps 20, 30 have a diameter of about 1.5-in. to about 3.0-in. (about 38.1 mm to about 76.2 mm). In one illustrative embodiment, the meat crisp 20 has a diameter of between about 2.48-in. to about 2.5-in. (about 63 mm to about 63.5 mm). In another embodiment, the meat crisp 30 has a diameter of between about 1.55-in. to about 1.75-in. (about 39.4 mm to about 44.5 mm). During the dehydration process, the meat crisps 20, 30 may experience shrinkage or a loss of dimension of about 0.25-in. to about 1.75-in. (about 6.35 mm to about 44.45 mm). In one embodiment, the dimension loss during dehydration is about 1.0-in. to about 1.25-in. (about 25.4 mm to about 31.75 mm). In addition to the individual meat crisps 10 having a variety of diameters or sizes, each meat crisp itself may have a variety of diameters such that the meat crisp is not entirely uniform. The meat crisps 20, 30 generally have a thickness of about 0.025-in. to about 0.25-in. (about 0.635 mm to about 6.35 mm). By one approach, the meat crisps 20, 30 have a thickness of about 0.05-in. to about 0.1-in. (about 1.27 mm to about 2.54 mm). In one illustrative approach, the meat crisp has a thickness of about 0.02-in. (about 0.508 mm) to about 0.04-in. (about 1.016 mm). In another illustrative approach, the meat crisp has a thickness of about 0.025-in (about 0.635 mm) to about 0.035-in. (about 0.889 mm). In one embodiment, the meat crisps have a thickness of about 0.03-in. (about 0.762 mm).

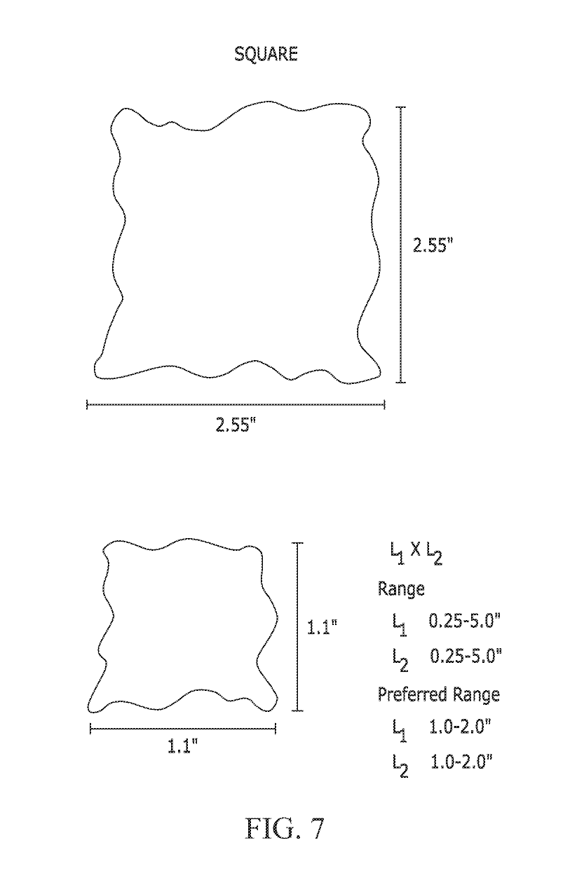

FIG. 7 illustrates another two exemplary meat crisps 40, 50 that may be produced according to the processes described herein. The crisps 40, 50 have generally square configurations. Each has a length that is roughly identical or similar. In some embodiments, the meat crisps 40, 50 may have a length of about 0.25-in. to about 5.0-in. (about 6.35 mm to about 127 mm). In other embodiments, the meat crisps 40, 50 may have a length of about 1-in. to about 2-in. (about 25.4 mm to about 50.8 mm). As illustrated in FIG. 7, the meat crisp 40 may have a length of about 2.55-in. (about 64.8 mm), and the meat crisp 50 may have a length of about 1.1-in. (about 27.9 mm). The meat crisps 40, 50 generally have a thickness of about 0.025-in. to about 0.25-in. (about 0.635 mm to about 6.35 mm). By one approach, the meat crisps 40, 50 have a thickness of about 0.05-in. to about 0.1-in. (about 1.27 mm to about 2.54 mm). In one illustrative approach, the meat crisp has a thickness of about 0.02-in. (about 0.508 mm) to about 0.04-in. (about 1.016 mm). In another illustrative approach, the meat crisp has a thickness of about 0.025-in (about 0.635 mm) to about 0.035-in. (about 0.889 mm). In one embodiment, the meat crisps have a thickness of about 0.03-in. (about 0.762 mm).

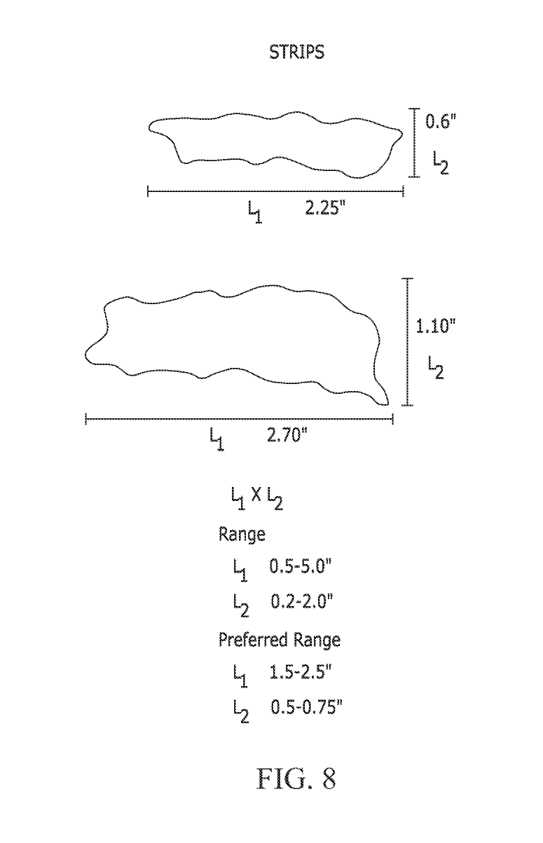

FIG. 8 illustrates another two exemplary meat crisps 60, 70 that may be produced according to the processes described herein. The crisps 60, 70 have a generally rectangular or strip configuration. The meat crisps 60, 70 may have a length of about 0.5-in. (about 6.35 mm) to about 5.0-in. (about 127 mm) and a second length or width of about 0.2-in. (about 5.1 mm) to about 2.0-in. (about 50.8 mm). In another configuration, the meat crisps 60, 70 may have a length of about 1.5-in. (about 38.1 mm) to about 2.5-in. (about 63.5 mm) and a width of about 0.5-in. (about 12.7 mm) to about 0.75-in. (about 19.1 mm). As illustrated in FIG. 8, the meat crisp 60 may have a length of about 2.25-in. (about 57.12 mm) and a width of about 0.6-in. (15.2 mm), and the meat crisp 70 may have a length of about 2.7-in. (68.6 mm) and a width of about 1.1-in. (about 27.9 mm). The meat crisps 60, 70 generally have a thickness of about 0.025-in. to about 0.25-in. (about 0.635 mm to about 6.35 mm). By one approach, the meat crisps 60, 70 have a thickness of about 0.05-in. to about 0.1-in. (about 1.27 mm to about 2.54 mm). In one illustrative approach, the meat crisp has a thickness of about 0.02-in. (about 0.508 mm) to about 0.04-in. (about 1.016 mm). In another illustrative approach, the meat crisp has a thickness of about 0.025-in (about 0.635 mm) to about 0.035-in. (about 0.889 mm). In one embodiment, the meat crisps have a thickness of about 0.03-in. (about 0.762 mm).

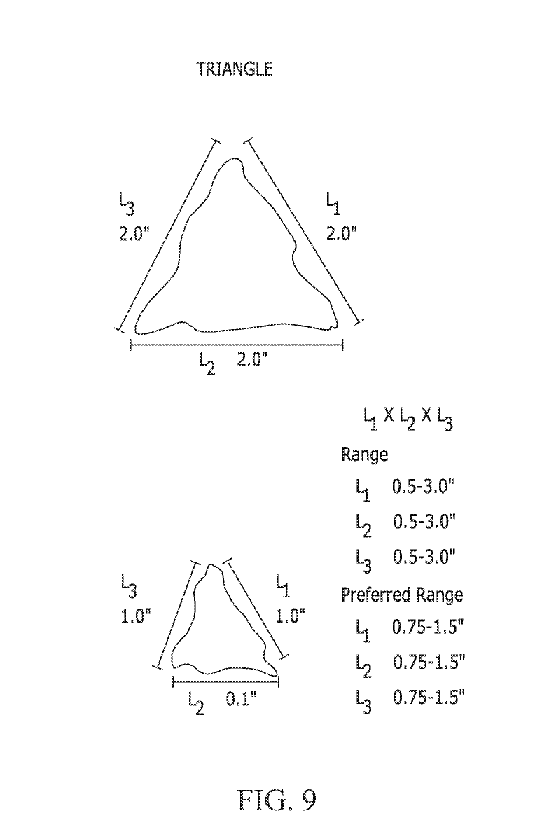

FIG. 9 illustrates another two exemplary meat crisps 80, 90 that may be produced according to the processes described herein. Further, the crisps 80, 90 have a generally triangular configuration. By one approach, the crisps 80, 90 have sides with lengths that are roughly identical or similar lengths such that the crisps 80, 90 form roughly equilateral triangles. The sides of the meat crisps 80, 90 may have lengths of about 0.5-in. (about 12.7 mm) to about 3.0-in. (about 76.2 mm). In another configuration, the sides of the meat crisps 80, 90 may have lengths of about 0.75-in. (about 19.1 mm) to about 1.5-in. (about 38.1 mm). As illustrated in FIG. 9, the sides of the meat crisp 80 may have lengths of about 2.0-in. (about 50.8 mm), and the sides of the meat crisp 70 may have lengths of about 1.0-in. (about 25.4 mm). The meat crisps 80, 90 generally have a thickness of about 0.025-in. to about 0.25-in. (about 0.635 mm to about 6.35 mm). By one approach, the meat crisps 80, 90 have a thickness of about 0.05-in. to about 0.1-in. (about 1.27 mm to about 2.54 mm). In one illustrative approach, the meat crisp has a thickness of about 0.02-in. (about 0.508 mm) to about 0.04-in. (about 1.016 mm). In another illustrative approach, the meat crisp has a thickness of about 0.025-in (about 0.635 mm) to about 0.035-in. (about 0.889 mm). One illustrative example includes a thickness of about 0.03-in. (about 0.762 mm).

To illustrate the teachings described herein, a number of different meat crisps were prepared, as outlined in the below charts. The first chart lists the measured values of the meat logs prior to the thermal processing steps and the second chart below lists the measured values or dehydration yield of the meat crisps formed after dehydrating slices of the meat logs.

| | Sample A | Sample B | Sample C | Sample D | Sample E | Sample F | Sample G |
|---|---|---|---|---|---|---|---|
| Ash (PERCENT) | 2.34 | 2.65 | 2.52 | 2.38 | 2.23 | 2.96 | 6.10 |
| Fat (PERCENT) | 10.83 | 7.71 | 11.62 | 8.26 | 10.48 | 7.5 | 4.75 |
| Moisture (PERCENT) | 68.55 | 71.44 | 65.55 | 70.32 | 68.19 | 71.46 | 75.41 |
| Protein (PERCENT) | 19.11 | 18.74 | 20.56 | 19.89 | 18.17 | 17.13 | 13.71 |
| Salt (PERCENT) | 1.79 | 1.87 | 1.96 | 1.63 | 1.66 | 2.18 | 1.59 |
| Fat (PERCENT) | 25.55 | 26.88 | 30.65 | 23.93 | 26.67 | 23.61 | 16.42 |
| Moisture (PERCENT) | 5.02 | 4.93 | 4.68 | 5.18 | 4.79 | 4.83 | 9.67 |
| Protein (PERCENT) | 60.2 | 59.21 | 57.64 | 61.61 | 57.31 | 56.28 | 44.94 |
| Salt (PERCENT) | 5.52 | 6.05 | 5.86 | 5.24 | 4.94 | 7.22 | 8.37 |
| pH | 6.22 | 6.29 | 6.2 | 6.22 | 6.26 | 6.26 | 5.38 |
| Aw Reading | 0.434 | 0.445 | 0.427 | 0.412 | 0.403 | 0.418 | 0.51 |
| Crispness (kg/sec) | 35.797 | 58.673 | 36.129 | 50.78 | 47.508 | 54.336 | 102 |
| Crispness - Std Dev | 4.865 | 8.977 | 9.063 | 8.204 | 14.424 | 7.344 | |
| Color - L Value | 41.277 | 33.466 | 43.285 | 32.528 | 42.627 | 34.179 | 31.55 |
| Color - a Value | 8.196 | 9.574 | 9.32 | 8.432 | 10.243 | 9.65 | 10.09 |
| Color - b Value | 22.205 | 14.591 | 23.856 | 13.76 | 23.778 | 15.209 | 11.17 |
| Dehydration Yield | 30.75% | 30.08% | 33.18% | 31.17% | 32.41% | 29.83% | |

As illustrated, a number of different raw materials were prepared and processed into meat crisps. Sample A was primarily comprised of a turkey breast trim; Sample B was primarily comprised of shaved, oven roasted, white turkey meat. Both samples A and B are free of starch. Sample C was primarily comprised of turkey breast trim and broth; Sample D was primarily comprised of shaved oven roasted turkey and broth; Sample E was primarily comprised of turkey breast trim and starch; Sample F was primarily comprised of shaved oven roasted turkey and starch. Sample G was primarily comprised of oven roasted white turkey breast, and, after dehydration, resulted in a jerky-like chip that started like a crispy or crunchy chip during mastication and finished chewing like a meat jerky such that the meat crisp is worked down gradually and does not dissolve like a potato chip or form a bolus. Samples A through F resulted in a product that retained its chip-like mouthfeel during mastication. The broth and the starch that was added to samples A through G was between about 1.0% to 1.5% of the formula such that the meat logs were primarily comprised of turkey meat.

As illustrated above, the meat crisps may have a crispness value of less than about 60 kg·seconds. In one approach, the meat crisps may have a crispness value of about 35kg·seconds to about 60 kg·seconds.

Those skilled in the art will recognize that a wide variety of modifications, alterations, and combinations can be made with respect to the above described embodiments without departing from the scope of the disclosure, and that such modifications, alterations, and combinations are to be viewed as being within the ambit of the inventive concept.

1. A meat crisp product comprising:
a crunchy meat crisp comprised of at least a ground meat, the ground meat being dehydrated and having a water activity (A_{w}) in a range of about 0.3 to about 0.6, a moisture percentage in a range of about 4.5% to about 15%, a crisp thickness in a range of about 0.025-in. (about 0.635 mm) to about 0.25-in. (about 6.35 mm), and a crispness value of less than about 731 kg·seconds.

2. The meat crisp product of claim 1 wherein the water activity is about 0.4 to about 0.55.

3. The meat crisp product of claim 1 wherein the moisture percentage is about 4.5% to about 12%.

4. The meat crisp product of claim 1 wherein the crisp thickness is about 0.02-in. (about 0.508 mm) to about 0.04-in. (about 1.016 mm).

5. The meat crisp product of claim 1 further comprising the meat crisp having a fat percentage about 6% to about 30%.

6. (canceled)

7. The meat crisp product of claim 1 further comprising the meat crisp having a protein percentage of about 40% to about 75% .

8. (canceled)

9. (canceled)

10. (canceled)

11. The meat crisp product of claim 1 further comprising the meat crisp having a pH of about 4.75 to about 6.5.

12. (canceled)

13. The meat crisp product of claim 1 wherein the meat crisp is prepared from a raw meat mixture including the ground meat having a particle size in a range of about 0.0625-in. (about 1.59 mm) to about 0.5-in. (about 12.7 mm).

14. The meat crisp product of claim 13 wherein the particle size is about 0.078-in. (about 1.98 mm) to about 0.188-in. (about 4.78 mm).

15. (canceled)

16. The meat crisp product of claim 13 wherein the raw meat mixture comprises about 60% to about 95% of raw meat, added water of about 5% to about 30%, and added, non-water ingredients of less than about 10% of the raw meat mixture.

17. The meat crisp product of claim 1 wherein the crispness value of the crunchy meat crisp is less than about 500 kg·seconds.

18. (canceled)

19. The meat crisp product of claim 16 wherein the raw meat mixture comprises about 30% added water, about 5% added, non-meat ingredients, and about 65% meat product.

20. The meat crisp product of any of claims 16 wherein the raw meat mixture comprises about 5% added water, about 2% added, non-meat ingredients, and about 93% meat product.

21. A meat crisp product comprising:
a crunchy meat crisp comprised of meat including at least one of a whole muscle meat product or a whole muscle meat batter, the meat being dehydrated and having a water activity in a range of about 0.3 to about 0.6, a moisture percentage in a range of about 5% to about 15%, a crisp thickness in a range of about 0.025-in. (about 0.635 mm) to about 0.25-in. (about 6.35 mm), and a crispness value of less than about 731 kg·seconds.

22. The meat crisp product of claim 21 wherein the water activity is about 0.4 to about 0.55.

23. The meat crisp product of claim 21 wherein the moisture percentage is about 4.5% to about 12%.

24. The meat crisp product of claim 21 wherein the crisp thickness is about 0.02-in. (about 0.508 mm) to about 0.04-in. (about 1.016 mm).

25. The meat crisp product of claim 21 further comprising the meat crisp having a fat percentage of about 6% to about 30%.

26. (canceled)

27. The meat crisp product of claim 21 further comprising the meat crisp having a protein percentage of about 40% to about 75% .

28. (canceled)

29. (canceled)

30. (canceled)

31. (canceled)

32. (canceled)

33. The meat crisp product of claim 21 wherein the meat crisp is prepared from a raw meat mixture including whole muscle meat portions having a piece size of about 0.5-in. (about 12.7 mm) to about 1.0-in. (about 25.4 mm).

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)
